(19) United States
(12) Patent Application Publication
(10) Pub. No.: US 2013/0035423 A1
(43) Pub. Date: Feb. 7, 2013

(54) RAPID HYDRAULIC BINDER FOR CONCRETE PARTS AND STRUCTURES

(71) Applicants: Serge Sabio, Saint Just Chaleyssin (FR); Xiaolin Pardal, Lyon (FR); Christine Chaumilliat, Oullins (FR)

(72) Inventors: Serge Sabio, Saint Just Chaleyssin (FR); Xiaolin Pardal, Lyon (FR); Christine Chaumilliat, Oullins (FR)

(73) Assignee: LARFARGE, Paris (FR)

(21) Appl. No.: 13/642,263

(22) PCT Filed: Apr. 19, 2011
(86) PCT No.: PCT/FR2011/050902

§ 371 Date: Oct. 25, 2012

(30) Foreign Application Priority Data
Apr. 20, 2010 (FR) 1052992

(51) Int. Cl. C08K 3/34; C08L 33/04; C08L 33/20; C08L 33/24; C08L 33/26; C08K 3/00; C08K 3/20

(52) U.S. Cl. 524/5; 524/2; 524/456

(57) ABSTRACT

A rapid hydraulic binder includes cement; a setting and hardening accelerator including hydrated calcium silicate seeds, a first superplasticizer and a second superplasticizer different from the first superplasticizer and having a maximum fluidizing action at 20° C. after the maximum fluidizing action at 20° C. of the first superplasticizer.

The invention relates to rapid hydraulic binder compositions used in the manufacture of concrete parts and structures.

The expression “rapid hydraulic binders” for mortar or concrete is understood to mean, according to the present invention, quick setting and hardening hydraulic binders. The concretes comprising such binders and their compositions, once used, acquire significant short-term mechanical characteristics. They preferably have a compressive strength CS of at least 1 MPa at 4 hours, for fluid concretes, and at least approximately 1 MPa at 5 hours, for self-placing (or self-compacting) concretes. In addition, they have a compressive strength CS of at least 12 MPa at 24 h. In addition, the workability time for fluid or self-placing (or self-compacting) concretes is preferably from one hour thirty minutes minimum to two hours maximum.

The workability of fluid concretes is measured by the slump height with the Abrams cone—or slump value—(according to the French standard NF P 18-451 of December 1981) and a concrete is considered to be fluid when this slump is at least 150 mm and preferably at least 180 mm.

The workability of self-placing (or self-compacting) concretes is generally measured from the slump flow, according to the procedure described in the document entitled “Specification and Guidelines for Self Compacting Concrete, EFNARC, February 2002, pp. 19-23”; the value of the slump flow is greater than 650 mm for self-compacting concretes (and generally less than 800 mm).

The workability time corresponds to the time during which the concrete in the fresh state can be satisfactorily used. It is in practice the time during which the slump height or the slump flow is greater than a given threshold.

The invention relates to concretes and more particularly to fluid or self-placing (or self-compacting) concretes intended for the preparation of parts and structures, for example factory-premanufactured parts, or on-site constructions, in particular walls made of concrete, slabs, and the like.

The patent application EP 1 893 548, filed on behalf of the company Lafarge and Chryso, describes a rapid hydraulic binder comprising cement, a superplasticizer, calcium nitrite and a formic derivative. The formic derivative can be in aldehyde form and corresponds, for example, to formaldehyde.

Although such a rapid hydraulic binder can be used to prepare a fluid or self-placing (or self-compacting) concrete, it exhibits the disadvantage of using a formic derivative which, at least in the case of formaldehyde, is a toxic compound.

There thus exists a need for a process for the manufacture of concrete parts and structures having a long workability time, resulting in a rapid acquisition of the short-term mechanical strengths, even at temperatures lower than 10° C., and thus making it possible to increase the rate of reuse of the formworks, the concrete using a rapid hydraulic binder not comprising a toxic formic derivative.

With this aim, the present invention provides a hydraulic binder comprising:
from 99.5 to 90% by mass, preferably from 99 to 95% by mass, of cement, with respect to the mass of the hydraulic binder;
from 0.5 to 10% by mass, preferably from 1 to 5% by mass, with respect to the mass of the hydraulic binder, of the combination of the following components:
a setting and hardening accelerator comprising calcium silicate hydrate seeds;
a first superplasticizer; and
a second superplasticizer which is different from the first superplasticizer and which has a maximum plasticizing action at 20° C. subsequent to the maximum plasticizing action at 20° C. of the first superplasticizer.

There are advantages to the invention, since it makes possible the manufacture of a fluid or self-compacting (self-placing) concrete using a hydraulic binder not comprising a toxic formic derivative.

In particular, advantageously, the present invention makes possible the manufacture of concrete compositions which are easy to use. These compositions have a suitable rheology, preferably involving a workability time (after mixing) of one hour minimum and of two hours maximum and a very quick hardening phase.

Advantageously, the present invention makes possible the manufacture of a fluid concrete, in particular a fluid concrete exhibiting a slump of at least 15 cm, preferably at least 18 cm, at 90 minutes.

Advantageously, the present invention makes possible the manufacture of a self-placing concrete, in particular a self-placing concrete exhibiting a slump flow of greater than 650 mm at 90 minutes.

The invention has the advantage of being able to be used in the building industry, the chemical industry (admixture producers), the construction industry, the cement industry or the construction markets (building, civil engineering or prefabrication factory). In particular, the rapid hydraulic binder according to the invention can be used in the construction and/or repair of roadways. Furthermore, the rapid hydraulic binder according to the invention can be used for the accelerated removal of concrete parts from formwork, in particular for producing walls using rapid removal from formwork and for producing prefabricated beams.

The invention also relates to an accelerator mixture for a hydraulic binder comprising cement, the mixture comprising a setting and hardening accelerator comprising calcium silicate hydrate seeds; a first superplasticizer; and a second superplasticizer which is different from the first superplasticizer and which has a maximum plasticizing action at 20° C. subsequent to the maximum plasticizing action at 20° C. of the first superplasticizer.

The invention also relates to a concrete or mortar comprising a rapid hydraulic binder according to the invention mixed with water.

The expression “hydraulic binder” is understood to mean, according to the present invention, a pulverulent material which, mixed with water, forms a paste which sets and hardens by a series of hydration reactions and which, after hardening, retains its strength and its stability even under water. The hydraulic binder can be a cement according to the standard EN 197-1.

Other advantages and characteristics of the invention will become clearly apparent on reading the description and examples, given purely by way of illustration and without implied limitation, which will follow.

The expression “hydraulic composition” is understood to mean, according to the present invention, a mixture of a hydraulic binder with mixing water, optionally aggregates, optionally adjuvants and optionally mineral admixtures. A hydraulic composition can, for example, be a high performance concrete, an ultra-high performance concrete, a self-placing concrete, a self-leveling concrete, a self-compacting concrete, a fibre-reinforced concrete, a ready-to-use concrete or a colored concrete. The term “concrete” is also understood to mean concretes which have been subjected to a finishing operation, such as bush-hammered concrete, deactivated or washed concrete, or polished concrete. This definition also comprises prestressed concrete. The term “concrete”, comprises mortars; in this precise case, the concrete comprises a mixture of a hydraulic binder, sand, water, optionally adjuvants and optionally mineral admixtures. The term “concrete” according to the invention denotes without distinction fresh concrete or hardened concrete. Preferably, the hydraulic composition according to the invention is a cement grout, a mortar or a concrete. The hydraulic composition according to the invention can be used directly on site in the fresh state and poured into a formwork suitable for the target application, or also in prefabrication, or also as coating on a solid support.

The term “setting” is understood to mean, according to the present invention, a change into the solid state of a hydraulic binder by chemical hydration reaction. Setting is generally followed by the hardening phase.

The term “hardening” is understood to mean, according to the present invention, the increase in the mechanical strengths of a hydraulic binder after the end of the setting phase.

The term “aggregates” is understood to mean, according to the present invention, gravel, grit and/or sand.

The expression “mineral admixtures” is understood to mean, according to the present invention, a finely divided mineral material used in the concrete in order to improve certain properties or to confer specific properties on it. They are, for example, flyash (as defined in the standard EN 450), silica fume (as defined in the standard prEN 13263:1998 or NF P 18-502), slags (as defined in the standard NF P 18-506), calcareous admixtures (as defined in the standard NF P 18-508) and siliceous admixtures (as defined in the standard NF P 18-509).

The expression “Portland cement” is understood to mean, according to the present invention, a cement of CEM I, CEM II, CEM III, CEM IV or CEM V type according to the “Ciment” [Cement] standard NF EN 197-1.

The term “setting and hardening accelerator” is understood to mean, according to the present invention, an adjuvant which decreases the time which precedes the start of the setting of a hydraulic binder and accelerates the acquisition of mechanical strengths of the hydraulic binder, in particular the compressive strength.

The expression “plasticizer/water reducer” is understood to mean, according to the present invention, an adjuvant which, without modifying the consistency, makes it possible to reduce the water content of a given concrete, or which, without modifying the water content, increases the slump/slump flow of the concrete, or which produces the two effects at the same time. The standard EN 934-2 specifies that the reduction of water must be greater than 5%. The water reducers can, for example, be based on lignosulfonic acids, on hydroxycarboxylic acids or on treated carbohydrates.

The expression “superplasticizer” or “superfluidizer” or “high-range water reducer” is understood to mean, according to the present invention, a water reducer which makes it possible to reduce by more than 12% the amount of water necessary for producing a concrete. A superplasticizer exhibits a plasticizing action since, for the same amount of water, the workability time of the concrete is increased in the presence of the superplasticizer.

The expression “immediate effect superplasticizer” is understood to mean, according to the present invention, a superplasticizer having a maximum plasticizing action at 20° C. which is obtained generally in the first 15 minutes following the initial contact of the superplasticizer with the hydraulic binder for conventional dosages.

The expression “delayed effect superplasticizer” is understood to mean, according to the present invention, a superplasticizer having a plasticizing action which increases over time at least over a portion of the workability window desired for the hydraulic composition. The maximum plasticizing action at 20° C. of the superplasticizer is then obtained at least more than fifteen minutes after the initial contact of the superplasticizer with the hydraulic binder. The plasticizing action of the immediate effect superplasticizer and of the delayed effect superplasticizer is measured by a slump flow and/or slump measurement, for example according to the standard EN 12350-2 “Essais pour béton frais—Partie 2: Essai d'affaissement” [Test for fresh concrete—Part 2: Slump test]. The plasticizing action of the superplasticizer is at a maximum when the slump flow/slump measured for the hydraulic composition comprising only this superplasticizer is at a maximum.

The increase in the plasticizing action of the superplasticizer can be obtained by an increase in the ability of the superplasticizer to be adsorbed by the mineral components (in particular the cement grains) of the hydraulic composition. With this aim, one possibility consists in increasing the density of anionic charges of the superplasticizer. An increase in the density of charges of the superplasticizer can be obtained by two different phenomena which can take place simultaneously:
the increase in the number of charges carried by the polymer; and
the reduction in the molecular weight of the polymer.

The reduction in the molecular weight of the superplasticizer can be obtained by choosing a superplasticizer comprising a main chain and pendent chains (at least three) which are connected to the main chain and which can separate off from the main chain when the superplasticizer is in the hydraulic composition.

The separation of pendent chains and/or the increase in the number of charges carried by the superplasticizer can be obtained by choosing a superplasticizer comprising hydrolyzable chemical functional groups which, under the effect of hydroxide (OH⁻) ions in the hydraulic composition, can be converted to provide carboxylate COO⁻ functional groups. The hydrolyzable chemical functional groups are, for example, anhydrides, esters and amides. A hydrolyzable polymer is a polymer comprising chemical functional groups which can be hydrolyzed under the basicity conditions and within the workability window of the hydraulic composition.

Setting and Hardening Accelerator

According to one embodiment, the setting and hardening accelerator comprises, in addition to the calcium silicate hydrate seeds, another component also having a setting and hardening accelerating action.

According to one embodiment, the setting and hardening accelerator additionally comprises a calcium salt.

According to one embodiment, the calcium salt is calcium nitrite. According to another embodiment, the calcium salt is calcium nitrate or a mixture of calcium nitrite and calcium nitrate. Preferably, the calcium salt is water-soluble. Preferably, the calcium salt is not a calcium carbonate.

The ratio by mass of the calcium silicate hydrate seeds to the calcium salt can vary from 2 to 98% and preferably from 10 to 50%.

The setting and hardening accelerator, comprising the calcium silicate hydrate seeds and optionally the calcium salt, is present in the composition of the accelerator mixture in amounts which may vary from 25 to 90% by dry mass, with respect to the dry accelerator mixture, preferably from 50 to 90%. In general, the amount of the setting and hardening accelerator, comprising the calcium silicate hydrate seeds and optionally the calcium salt, in the final hydraulic binder can vary from 0.1 to 9%, preferably from 0.2 to 5% and more preferably from 0.2 to 2% by mass on a dry basis, with respect to the dry hydraulic binder.

According to one embodiment, the rapid hydraulic binder does not comprise formaldehyde. It can optionally comprise a nontoxic formic derivative, such as calcium formate. According to one embodiment, the rapid hydraulic binder does not comprise a formic derivative.

Immediate Effect Superplasticizer or First Superplasticizer

The first superplasticizer can be any immediate effect superplasticizer conventionally used in industry, for example those defined in the European standard EN 934-2.

Examples of the first superplasticizer are superplasticizers of the polyphosphonate polyox or polysulfonate polyox type or of poly(alkylene oxide) polycarboxylate type (also known as PCP). An example of first superplasticizer is that described in the documents EP-A-537 872, US2003/0127026 and US 2004/0149174.

An example of first superplasticizer corresponds to a copolymer comprising a unit of formula (I):

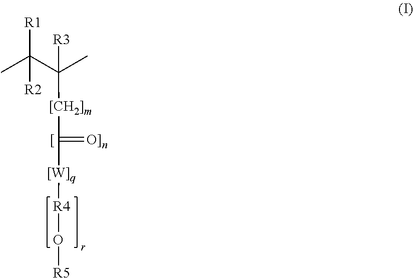

and a unit of formula (II):

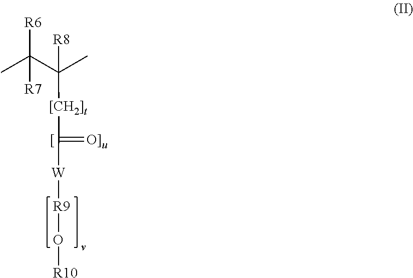

where R1, R2, R3, R6, R7 and R8, which are identical or different, are a hydrogen atom, a linear or branched alkyl radical having from 1 to 20 carbon atoms, an aromatic radical or a —COOR11 radical with R11 representing a hydrogen atom, a linear or branched alkyl radical having from 1 to 4 carbon atoms, a monovalent, divalent or trivalent cation or an ammonium group;

R10 is a hydrogen atom, a linear or branched alkyl radical having from 1 to 20 carbon atoms or an aromatic radical;

R4 and R9, which are identical or different, are a linear or branched alkyl radical having from 2 to 20 carbon atoms;

R5 is a hydrogen atom, an alkyl group having from 1 to 20 carbon atoms or an anionic or cationic group, for example a phosphonate group, a sulfonate group, a carboxylate group, and the like;

W is an oxygen or nitrogen atom or an NH radical;

m and t, which are identical or different, are integers which can vary from 0 to 2;

n and u, which are identical or different, are integers equal to 0 or 1;

q is an integer equal to 0 or 1;

r and v, which are identical or different, are integers which can vary from 0 to 500;

and the molar mass of said copolymer varies from 10 000 to 400 000 daltons.

Preferably, the R1 or R6 radical is a hydrogen atom. Preferably, the R2 or R7 radical is a hydrogen atom. Preferably, the R3 or R8 radical is a methyl radical or hydrogen. Preferably, the R4 or R9 radical is an ethyl radical.

Preferably, the copolymer used according to the invention or one of its salts has an integer r from 1 to 300, preferably from 20 to 250, more preferably from 40 to 200 and more preferably still from 40 to 150.

The first superplasticizer can correspond to a salt of the copolymer defined above.

The copolymer can comprise several different units according to the formula (I) having, in particular, different R5 radicals.

An example of first superplasticizer is that obtained by polymerization:
of an ionic monomer of the phosphonic, sulfonic or carboxylic type, preferably of the carboxylic type and advantageously of the (meth)acrylic type; and
of a monomer of polyoxyalkylene glycol (having from 1 to 4 carbon atoms) (meth)acrylate type, for example of polyethyleneglycol (PEG) (meth)acrylate type, the molecular weight of which is, for example, from 100 to 10 000, preferably from 500 to 7500 and advantageously from 750 to 5000.

The first monomer/second monomer molar ratio can vary greatly, for example from 90/10 to 45/55 and preferably from 80/20 to 55/45.

It is possible to use one or more third monomer(s), for example those chosen from:

(a) acrylamide type, for example N,N-dimethylacrylamide, 2,2′-dimethylamino (meth)acrylate or its salts, 2,2′-dimethylaminoalkyl (meth)acrylate or its salts with the alkyl group in particular ethyl and propyl, and generally any monomer comprising a functional group of amine or amide type;

(b) hydrophobic type, for example alkyl, having from 1 to 18 carbon atoms, in particular methyl or ethyl, (meth)acrylate.

The amount of this third monomer can vary from 5 to 25 mol % of the total of the monomers.

The first superplasticizer is preferably provided in a liquid, solid or waxy form.

The dosage of the first superplasticizer with respect to the hydraulic binder generally varies from 0.1 to 5% by mass (percentages calculated from the solids content of the first superplasticizer), preferably from 0.1 to 2% by mass, with respect to the mass of the hydraulic binder. When the first superplasticizer is liquid, the amount of the first superplasticizer is preferably from 1 to 10, preferably from 2 to 7, litres per cubic metre of the fresh concrete.

The first superplasticizer can correspond to a mixture of immediate effect superplasticizers, to a mixture of at least one immediate effect superplasticizer and a plasticizer, for example a lignosulfonate, or to a mixture of at least one immediate effect superplasticizer and a molecule of the gluconate type.

Delayed Effect Superplasticizer or Second Superplasticizer

The second superplasticizer is a superplasticizer having a plasticizing action which increases at least temporarily over time under the basicity conditions and within the workability window of the hydraulic composition. Preferably, the second superplasticizer does not have an initial plasticizing action, that is to say that the initial slump/slump flow of the hydraulic composition (at less than 5 minutes after mixing the components of the hydraulic composition) does not vary, whatever the concentration of the delayed effect superplasticizer.

According to one embodiment of the present invention, the density of adsorption sites of the second superplasticizer increases in the workability window of the hydraulic composition.

According to one implementational example of the present invention, the anionicity of the second superplasticizer increases in the hydraulic composition in the workability window.

The second superplasticizer can comprise a polymer which can be hydrolyzed under the basicity conditions and in the workability window of the hydraulic composition. As the hydraulic composition obtained during the manufacture of a concrete according to the invention has a basic pH, hydrolysis reactions take place which result in a modification to the structure of the hydrolyzable polymer and in a modification to the properties of the hydrolyzable polymer, in particular an increase in the plasticizing action of the hydrolyzable polymer. According to one embodiment, the hydrolyzable polymer is of the poly(alkylene oxide) polycarboxylate type.

Examples of delayed effect superplasticizers are described in the documents EP 1 136 508, WO 2007/047407 and US 2009/0312460.

An example of secondary superplasticizer corresponds to a copolymer comprising at least one unit according to the formula (I) and at least one unit according to the formula (II).

The second superplasticizer can correspond to a mixture of delayed effect superplasticizers.

The second superplasticizer can comprise a monomer chosen from acrylamide and its derivatives, acrylonitrile and its derivatives, alkyl acrylates, hydroxyalkyl acrylates, polyethylene glycol acrylates, carboxylic anhydrides which can be copolymerized and imides which can be copolymerized.

According to an embodiment, the second superplasticizer corresponds to a copolymer comprising at least one unit according to the formula (I) as defined above:

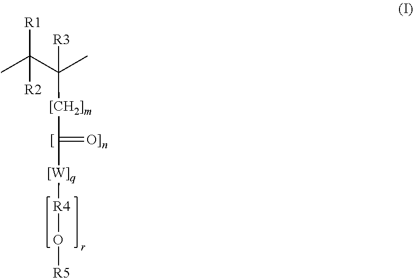

and at least one unit of formula (III):

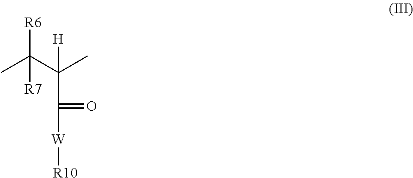

where R6, R7, R10 and W are as defined above.

According to one embodiment of the present invention, the ratio of the number of units of formula (III) to the total number of units of the delayed action superplasticizer is sufficient to result in an increase in the plasticizing action of the superplasticizer over time at least over a portion of the workability window desired for the hydraulic composition, so that the maximum plasticizing action at 20° C. of the superplasticizer is generally obtained at least more than 15 minutes after the initial contact of the superplasticizer with the hydraulic binder.

According to one embodiment of the present invention, R3 is hydrogen, n is equal to 1, m is equal to 0 and q is equal to 1. In this case, the delayed effect superplasticizer can comprise just one unit of formula (III).

According to one embodiment of the present invention, R3 is an alkyl radical having 1 carbon atom, n is equal to 1, m is equal to 0 and q is equal to 1. In this case, when the number r of the units of formula (I) is greater than 100, the delayed action superplasticizer comprises more than 80% of units of formula (III), with respect to the total number of units of the delayed action superplasticizer. Preferably, when the number r of the units of formula (I) varies from 50 to 100, the delayed action superplasticizer comprises more than 70% of units of formula (III), with respect to the total number of units of the delayed action superplasticizer. Preferably, when the number r of the units of formula (I) is less than 50, the delayed action superplasticizer comprises more than 50% of units of formula (III), with respect to the total number of units of the delayed action superplasticizer.

According to one embodiment of the present invention, R3 is a hydrogen, n is equal to 0, m is equal to 1, q is equal to 1 and W is an oxygen atom. In this case, when the number r of the units of formula (I) is greater than 100, the delayed action superplasticizer comprises more than 80% of units of formula (III), with respect to the total number of units of the delayed action superplasticizer. Preferably, when the number r of the units of formula (I) varies from 50 to 100, the delayed action superplasticizer comprises more than 70% of units of formula (III), with respect to the total number of units of the delayed action superplasticizer. Preferably, when the number r of the units of formula (I) is less than 50, the delayed action superplasticizer comprises more than 50% of units of formula (III), with respect to the total number of units of the delayed action superplasticizer.

The second superplasticizer is present in the composition of the accelerator mixture in amounts which can vary from 1 to 5% by mass, which percentages are calculated from the solids contents of the constituents of the accelerator mixture. With respect to the mass of the final hydraulic binder, the amount of the second superplasticizer can vary from 0.01 to 1% by mass, preferably from 0.05 to 0.5% by mass (percentages calculated from the solids content of the second superplasticizer), with respect to the mass of the hydraulic binder. The amount of the second superplasticizer on a dry basis, with respect to the setting and hardening accelerator, can vary from 1 to 10%, with respect to the amount of the setting and hardening accelerator.

Hydraulic Binder and Hydraulic Composition

The rapid hydraulic binder intended for a hydraulic composition generally comprises, with respect to the mass of the dry hydraulic binder:
from 99.5 to 90% by mass of Portland cement; and
from 0.5 to 10% by mass of the accelerator mixture.

Advantageously, the rapid hydraulic binder comprises:
from 99 to 95% by mass of Portland cement; and
from 1 to 5% by mass of the accelerator mixture.

The Portland cement is typical and in accordance with the cement families described in the European standard EN 197-1. CEM1 52.5 N or R cements or CEM2 cements of 32.5, 32.5 R, 42.5 or 42.5 R type can be used. The cement can be of the HRI (à Haute Résistance Initiale [High Early Strength]) type.

Advantageously, the Portland cement is a cement preferably ground to a fineness of at least 3000 cm²/g, preferably of at least 3500 cm²/g.

The level of soluble alkali metals is preferably less than 1% by mass, advantageously less than 0.4% by mass, expressed as Na₂O equivalent. Advantageously, the amount of C₄AF is less than 8% by mass, advantageously less than 4% by mass, and the amount of C₃S in the clinker is greater than 60% by mass.

The final amount of the accelerator mixture depends on the temperature of use of the hydraulic composition, the exact process in which the hydraulic composition is used, the level of strengths to be obtained, and the like. Furthermore, this amount is adjusted according to the final amounts of the various components in the final mixture of the hydraulic composition.

The hydraulic composition can, in addition to the accelerator mixture, comprise other types of additives typically used in concretes.

Examples of additives which can be used are air-entraining agents, antifoam agents, corrosion inhibitors, shrinkage-reducing agents, fibres, pigments, rheology-modifying agents, hydration precursors, pumping aids, agents which reduce alkali reactions, reinforcing agents, water-repellent compounds and their mixtures.

In the case where the hydraulic composition is a concrete, the compounds of the concrete can be used in the following order:
according to a first embodiment, all of the components of the accelerator mixture are added from the start, during the mixing of the concrete, in the ready-mix concrete plant; the cement and the complete accelerator mixture are mixed together, namely the setting and hardening accelerator, the first superplasticizer and the second superplasticizer. The mixing in the ready-mix concrete plant can be carried out in a fixed mixer or in a concrete mixer truck, when the latter is used as mixer. The invention also relates to the process in which all of the components are introduced during the mixing of a rapid binder with the aggregates and the water.
according to a second embodiment, the setting and hardening accelerator, comprising the calcium silicate hydrate seeds and optionally a calcium salt, is added at a later time in comparison with the other components of the accelerator mixture, for example in the concrete mixer truck, before departure from the ready-mix concrete plant, or during the journey from the ready-mix concrete plant to the site, or on site, immediately before pouring. The invention also relates to the process in which the setting and hardening accelerator is introduced subsequent to the mixing of the other components of the rapid hydraulic binder with the aggregates and the water.

According to the second embodiment, the times chosen for this delayed introduction can be from 10 to 90 minutes, preferably from 20 to 60 minutes, after the mixing of the other components of the accelerator mixture, the first superplasticizer and/or the second superplasticizer. The invention also relates to the process in which the setting and hardening accelerator is introduced from 10 to 90 minutes, preferably from 20 to 60 minutes, subsequent to the mixing of the other components of the rapid hydraulic binder with the aggregates and the water.

The first embodiment is preferred, as the various constituents (cement, components of the accelerator mixture) can all be added in precisely determined amounts in a single stage in the ready-mix concrete plant.

Generally, the ratio by mass of effective water/dry binder (W/C ratio) generally varies from 0.3 to 0.65.

The final composition comprises conventional aggregates (sand, gravel and/or crushed rock). Preferably, the constituents of the final composition have a size of less than or equal to 20 mm, preferably of less than or equal to 10 mm in the case of self-placing (or self-compacting) concretes. The composition can thus be easily pumped.

The ratio by dry mass of aggregates/hydraulic binder generally varies from 4 to 5.

The concrete compositions according to the invention are easy to use and low in cost. They have a suitable rheology, preferably involving a workability time (after mixing) of one hour minimum and of from one and a half hours to two hours maximum and a very rapid hardening phase. The workability time of these concretes according to the invention generally varies from 1 h 30 to 2 hours. The term “workability time” is understood to mean the time during which fluidity is maintained, which corresponds to the time which precedes the start of setting; generally, the slump values (fluid concrete) are at least 15 cm, preferably at least 18 cm.

The concrete according to the invention can be a fluid concrete, in particular a fluid concrete exhibiting a slump at 90 minutes of at least 15 cm, preferably at least 18 cm. It can have a compressive strength at least of the order of 1 MPa, preferably at least of 2 MPa, at 4 h, counting from the end of the mixing, and at least of 12 MPa at 24 h, measured on cylindrical test specimens with dimensions of 16 cm×32 cm.

The concrete according to the invention can also be a self-placing concrete, in particular a self-placing concrete exhibiting a slump flow of greater than 650 mm at 90 minutes. It can have a compressive strength of the order of at least 1 MPa, preferably at least of 2 MPa, at 5 h, counting from the end of mixing, and at least of 12 MPa at 24 h, measured on cylindrical test specimens with dimensions of 16 cm×32 cm.

When the mixing is carried out in a concrete mixer truck, the time is counted from the moment when the final constituent of the concrete composition is introduced into the concrete mixer truck.

These two properties, sufficient workability time and high short-term strengths, make it possible to produce a precursor concrete composition in a ready-mix concrete plant and to subsequently transport it to a site by a concrete mixer truck, the composition rapidly hardening once poured. These qualities of the binder also make it possible to mechanically pump it by virtue of its fluidity and to pour or pump it into a formwork, a rapid hardening phase being obtained. It is thus possible to remove the formwork and then to rapidly reinstall the formwork, in order to be able to proceed to a fresh pouring of the concrete.

The rapid binder for fluid or self-placing (self-compacting) concretes according to the invention is easy to pump or to pour, in particular without vibration in the case of self-compacting concretes, which makes it, for example, particularly suitable for the manufacture of concrete walls.

The invention relates very particularly to the manufacture of concrete walls by pouring and/or pumping. The invention is of use in the manufacture of concrete walls at external temperatures varying in particular from 5° C. to 30° C., in particular of less than 10° C. A concrete wall can be defined in the building trade as “any solid vertical wall made of shuttered concrete”.

Furthermore, the invention also provides a manufacturing process, in particular a process for the manufacture of concrete walls, by removal of formwork twice daily at temperatures of less than or equal to 10° C., in particular using the accelerator mixture according to the invention. The invention provides such a process which thus makes it possible to pour two concrete walls in one day, even at low temperatures. The compositions according to the invention, which have rapid setting properties even at low temperature, make it possible to carry out this double removal of formwork. It is thus possible to break with the conventional approach and to carry out a double removal of formwork, even at low temperatures.

Examples illustrate the invention without limiting the scope thereof.

### EXAMPLES

The present invention is illustrated by the following nonlimiting examples. In the examples, the products and materials used were available from the following suppliers:

| | Product or material | Supplier |
|---|---|---|
| (1) | Portland cement | Lafarge - Saint-Pierre-La-Cour or |
| | | Lafarge - Le Havre |
| (2) | Sand 0/4 mm | Mauzac, France |
| (3) | Calcareous filler | Omya |
| | BETOCARB HP Orgon | |
| (4) | Adjuvant Glenium 27 | BASF |
| (5) | Adjuvant Glenium SKY537 | BASF |
| (6) | Adjuvant X-Seed | BASF |
| (7) | Adjuvant Rheotec Z60 | BASF |
| (8) | Adjuvant Chrysoxel Time | Chryso |
| (9) | Adjuvant SPAH8 | BASF |

The product X-Seed was a solution with a solids content of 20% comprising in particular calcium silicate hydrates (CSHs).

The products Glenium 27 and Glenium SKY537 were immediate action superplasticizers.

The product Rheotec Z60 was a delayed action superplasticizer.

Formulation of a Mortar Equivalent to a Concrete

The following concrete formulation (1) was considered:

TABLE 1
Concrete formulation (1)

| Component | Proportion per 1 m³ of fresh concrete | |
|---|---|---|
| Cement, Lafarge | 350 | kg |
| Calcareous filler, Orgon | 50 | kg |
| Sand 0-4 from the Mauzac site | 780 | kg |
| Sand 4-14 from the Mauzac site | 1107.5 | kg |
| Total water | 171.6 | kg |

According to the concrete equivalent mortar theory described in the paper entitled “La méthode du mortier de béton équivalent (MBE)-Un nouvel outil d'aide à la formulation des bétons adjuvantés” [The concrete equivalent mortar (CEM) method—A novel tool for helping in the formulation of adjuvant-comprising concretes] by A, Schwarzentruber and C. Catherine published in the journal Materials and Structures, Volume 33/Number 8, October 2000, it is possible to use a mortar having rheological and strength characteristics representative of what would be obtained with the concrete according to the formulation (1).

The mortar according to the following formulation (2) was equivalent to the concrete according to the formulation (1).

TABLE 2
Mortar formulation (2)

| Component | Proportion | |
|---|---|---|
| Cement, Lafarge | 550.9 | g |
| Calcareous filler, Orgon | 78.7 | g |
| Sand 0-4 from the Mauzac site | 1454.5 | g |
| Total water | 255.9 | g |

The cement was the cement produced by Lafarge originating from the Le Havre or Saint-Pierre-La-Cour site. This cement was of the CEM I 52.5 type according to the standard EN 197-1.

Protocol for the Preparation of the Mortar
The sands are placed in a mixing bowl;
T=0: mixing is begun at a slow speed (140 revolutions/min) and the wetting water is simultaneously added in 30 seconds, and then mixing is continued at a low speed (140 revolutions/min) up to 60 seconds;
At T=60 seconds: mixing is halted and the mixture is left standing for 4 minutes;
At T=5 minutes (T=0 for the rheology maintenance test): the Portland clinker is added and mixing is carried out at a low speed (140 revolutions/min) for 1 minute;
At T=6 minutes: the mixing water (+optional adjuvants) is added in 30 seconds (while mixing at a low speed (140 revolutions/min));
At T=6 minutes 30 seconds: mixing is carried out at high speed (280 revolutions/min) for 1 minute;
At T=7 minutes 30 seconds: mixing is halted.

Slump Flow Measurement Protocol

The principle of the slump flow measurement consisted in filling a reference truncated cone with a test composition and in then releasing said composition from the truncated cone in order to determine the surface area of the disk obtained when the composition finished slumping. The reference truncated cone corresponded to a reproduction on a ½ scale of the cone as defined by the standard NF P 18-451, 1981. The reference truncated cone had the following dimensions:
diameter of the circle of the upper base of the cone of: 50+/−0.5 mm;
diameter of the circle of the lower base: 100+/−0.5 mm; and
height: 150+/−0.5 mm.

The protocol for measuring the slump flow was as follows:
The reference truncated cone is filled in a single stage with the test mortar;
The mortar is distributed homogeneously in the truncated cone;
The upper surface of the truncated cone is leveled;
The truncated cone is raised vertically;
The highest point of the slump is measured to +/−1 mm and/or the slump flow is measured according to four diameters at 45° with a sliding caliper. The result of the slump flow measurement is the mean of the four values to +/−1 mm.

Method of Measuring the Compressive Strength

The compressive strength was measured on a parallelepipedal sample having a length of 16 cm, a width of 4 cm and a height of 4 cm according to the standard EN 196-1, whatever the term of the measurement.

For mortars produced according to the formulation (2), the targeted slump flow was greater than 200 mm for at least 90 minutes and the targeted compressive strength was greater than or equal to approximately 1 MPa after 4 hours, starting from the end of the mixing. For concretes produced according to the formulation (1), the targeted slump flow was greater than 500 mm for at least 90 minutes and the targeted compressive strength was greater than or equal to approximately 1 MPa after 4 hours, starting from the end of the mixing.

### Example 1

A liter of mortar according to the formulation (2) at 20° C. was prepared. The cement produced by Lafarge at the Le Havre site was used. The X-Seed solution was used as setting and hardening accelerator. The first superplasticizer, denoted SP, was Glenium 27. The second superplasticizer, denoted PH, was Rheotec Z60. Slump flow and compressive strength (CS) measurements were carried out at 20° C. while varying the concentration of the setting and hardening accelerator X-Seed. The concentrations were expressed as percentage by mass on a dry basis with respect to the mass of cement. The results of these tests are collated in the following table 3:

TABLE 3

| X- | | | | | | | | | | |
|---|---|---|---|---|---|---|---|---|---|---|
| Seed | SP | PH | | | | | | | | |
| (% by | (% by | (% by | | | | | | | | |
| mass | mass | mass | | | | | | | | |
| on a | on a | on a | | | | | | | | |
| dry | dry | dry | Slump flow (mm) | | | | | CS (MPa) | | |
| basis) | basis) | basis) | 5 min | 15 min | 30 min | 60 min | 90 min | 4 h | 6 h | 24 h |
| 0.81 | 0.15 | 0.20 | 300 | 320 | 355 | 340 | 290 | 0.92 | 4.8 | 37.7 |
| 1.62 | 0.15 | 0.25 | 350 | 350 | 345 | 295 | 115 | 2.7 | 13.7 | 37.2 |

The present invention has made it possible to obtain a workability time for the mortar of greater than 1 h 30 without resulting in a delay in the acquisition of the early strengths. A workability time of 1 h 30 was obtained while retaining the speed of acquisition of the early strengths. One explanation would be that the first superplasticizer plays a more important role in the delay in acquisition of the early strengths than the second superplasticizer. For this reason, since the present invention has made it possible to reduce the concentration of the first superplasticizer, the speed of acquisition of the early strengths has been retained, indeed even improved, in comparison with a mortar comprising only the first superplasticizer in a greater concentration. In addition, a workability time for the mortar of greater than 1 h 30 could be obtained by virtue of the plasticizing action of the second superplasticizer which increased over time.

### Example 2

A litre of mortar according to the formulation (2) was prepared at 20° C. The cement produced by Lafarge at the Le Havre site was used. A mixture of the product X-Seed and a calcium nitrite solution was used as setting and hardening accelerator. The calcium nitrite solution was an aqueous solution comprising 30% on a dry basis of calcium nitrite Ca(NO₂)₂.

The superplasticizer SP was Glenium 27. The superplasticizer PH was Rheotec Z60. Slump flow and compressive strength measurements were carried out at 20° C. while varying the concentration of the setting and hardening accelerator X-Seed and of the calcium nitrite solution. The concentrations were expressed as percentage by mass on a dry basis with respect to the mass of cement binder. The results of these tests are collated in the following table 4:

TABLE 4

| | Nitrite | | | | | | | | | | |
|---|---|---|---|---|---|---|---|---|---|---|---|
| X-Seed | solution | SP | PH | | | | | | | | |
| (% by | (% by | (% by | (% by | | | | | | | | |
| mass | mass | mass | mass | | | | | | | | |
| on a dry | on a dry | on a dry | on a dry | Slump flow (mm) | | | | | CS (MPa) | | |
| basis) | basis) | basis) | basis) | 5 min | 15 min | 30 min | 60 min | 90 min | 4 h | 6 h | 24 h |
| 0.81 | 0.75 | 0.15 | 0.20 | 335 | 370 | 355 | 350 | 265 | 0.73 | 5.6 | 35.6 |
| 0.81 | 1.5 | 0.20 | 0.15 | 350 | 360 | 370 | 355 | 170 | 2.7 | 13.3 | 39.0 |

A workability time for the mortar of greater than 1 h 30 was obtained without resulting in a delay in the acquisition of the early strengths. A workability time of 1 h 30 was thus obtained while retaining the speed of acquisition of the early strengths.

### Example 3

A litre of mortar according to the formulation (2) was prepared at 20° C. The cement produced by Lafarge at the Saint-Pierre-La-Cour site was used. The product X-Seed was used as setting and hardening accelerator. The concentration of X-Seed was 0.8%, expressed as percentage by mass on a dry basis with respect to the amount of cement. The superplasticizer SP was Glenium SKY537. The concentration of Glenium SKY537 was 0.25%, expressed as percentage by mass on a dry basis with respect to the amount of cement. The superplasticizer PH was Rheotec Z60. The concentration of Rheotec Z60 was 0.20%, expressed as percentage by mass on a dry basis with respect to the amount of cement. Slump flow and compressive strength measurements were carried out at 20° C. The results of these tests are collated in the following table 5:

TABLE 5

| X-Seed | SP | PH | | | | | | | | |
|---|---|---|---|---|---|---|---|---|---|---|
| (% by | (% by | (% by | | | | | | | | |
| mass | mass | mass | | | | | | | | |
| on a dry | on a dry | on a dry | Slump flow (mm) | | | | | CS (MPa) | | |
| basis) | basis) | basis) | 5 min | 15 min | 30 min | 60 min | 90 min | 4 h | 6 h | 24 h |
| 0.8 | 0.25 | 0.20 | 270 | 260 | 290 | 310 | 270 | 0.86 | 5.3 | 35.2 |

A workability time of the mortar of greater than 1 h 30 was obtained without resulting in a delay in the acquisition of the early strengths. A workability time of 1 h 30 was thus obtained while retaining the speed of acquisition of the early strengths.

### Example 4

A litre of mortar according to the formulation (2) was prepared at 20° C. The cement produced by Lafarge at the Saint-Pierre-La-Cour site was used. A mixture of the X-Seed product and the calcium nitrite solution described above was used as setting and hardening accelerator. The concentration of X-Seed was 0.8%, expressed as percentage by mass on a dry basis with respect to the amount of cement. The concentration of calcium nitrite solution was 1.5%, expressed as percentage by mass on a dry basis with respect to the amount of cement.

The superplasticizer SP was Glenium 27. The concentration of Glenium 27 was 0.25%, expressed as percentage by mass on a dry basis with respect to the amount of cement. The superplasticizer PH was Rheotec Z60. The concentration of Rheotec Z60 was 0.20%, expressed as percentage by mass on a dry basis with respect to the amount of cement. Slump flow and compressive strength measurements were carried out at 20° C. The results of these tests are collated in the following table 6:

TABLE 6

| | Nitrite | | | | | | | | | | |
|---|---|---|---|---|---|---|---|---|---|---|---|
| X-Seed | solution | SP | PH | | | | | | | | |
| (% by | (% by | (% by | (% by | | | | | | | | |
| mass | mass | mass | mass | | | | | | | | |
| on a dry | on a dry | on a dry | on a dry | Slump flow (mm) | | | | | CS (MPa) | | |
| basis) | basis) | basis) | basis) | 5 min | 15 min | 30 min | 60 min | 90 min | 4 h | 6 h | 24 h |
| 0.8 | 1.5 | 0.25 | 0.20 | 280 | 285 | 300 | 295 | 280 | 0.72 | 4.8 | 41.8 |

A workability time for the mortar of greater than 1 h 30 was obtained without resulting in a delay in the acquisition of the early strengths. A workability time of 1 h 30 was thus obtained while retaining the speed of acquisition of the early strengths.

### Example 5

A concrete according to the formulation (1) at 20° C. was prepared. The cement produced by Lafarge at the Le Havre site was used. The product X-Seed was used as setting and hardening accelerator. The concentration of X-Seed was 0.8%, expressed as percentage by mass on a dry basis with respect to the amount of cement. The superplasticizer SP was Glenium 27. The concentration of Glenium 27 was 0.15%, expressed as percentage by mass on a dry basis with respect to the amount of cement. The superplasticizer PH was Rheotec Z60. The concentration of Rheotec Z60 was 0.20%, expressed as percentage by mass on a dry basis with respect to the amount of cement.

Slump flow and compressive strength measurements were carried out at 20° C. The results of these tests are collated in the following table 7:

TABLE 7

| X-Seed | SP | PH | | | | | | | | |
|---|---|---|---|---|---|---|---|---|---|---|
| (% by | (% by | (% by | | | | | | | | |
| mass | mass | mass | | | | | | | | |
| on a dry | on a dry | on a dry | Slump flow (mm) | | | | | CS (MPa) | | |
| basis) | basis) | basis) | 5 min | 15 min | 30 min | 60 min | 90 min | 4 h | 5 h | 6 h |
| 0.8 | 0.15 | 0.20 | 650 | 680 | 730 | 700 | 540 | 0.7 | 1.5 | 2.7 |

A workability time for the mortar of greater than 1 h 30 was obtained without resulting in a delay in the acquisition of the early strengths. A workability time of 1 h 30 was thus obtained while retaining the speed of acquisition of the early strengths.

### Example 6

A concrete according to the formulation (1) at 20° C. was prepared. The cement produced by Lafarge at the Saint-Pierre-La-Cour site was used. The product X-Seed was used as setting and hardening accelerator. The concentration of X-Seed was 1%, expressed as percentage by mass on a dry basis with respect to the amount of cement. The superplasticizer SP was Glenium SKY537. The concentration of Glenium SKY537 was 0.15%, expressed as percentage by mass on a dry basis with respect to the amount of cement. The superplasticizer PH was Rheotec Z60. The concentration of Rheotec Z60 was 0.20%, expressed as percentage by mass on a dry basis with respect to the amount of cement.

Slump flow and compressive strength measurements were carried out at 20° C. The results of these tests are collated in the following table 8:

TABLE 8

| X-Seed | SP | PH | | | | | | | | |
|---|---|---|---|---|---|---|---|---|---|---|
| (% by | (% by | (% by | | | | | | | | |
| mass | mass | mass | | | | | | | | |
| on a dry | on a dry | on a dry | Slump flow (mm) | | | | | CS (MPa) | | |
| basis) | basis) | basis) | 5 min | 15 min | 30 min | 60 min | 90 min | 5 h | 6 h | 24 h |
| 1 | 0.15 | 0.20 | 600 | 570 | 630 | 620 | 510 | 1.5 | 2.9 | 30.2 |

A workability time for the mortar of greater than 1 h 30 was obtained without resulting in a delay in the acquisition of the early strengths. A workability time of 1 h 30 was thus obtained while retaining the speed of acquisition of the early strengths.

The examples described above have shown that, all conditions otherwise being equal, the hydraulic binder according to the invention has made possible the manufacture of a concrete which has a long workability time and which results in a rapid acquisition of the short-term mechanical strengths, independently of the source from which the cement is supplied.

1. A rapid hydraulic binder, comprising:
from 99.5 to 90% by mass of cement, with respect to the mass of the hydraulic binder;
from 0.5 to 10% by mass with respect to the mass of the hydraulic binder, of the combination of the following components:
a setting and hardening accelerator comprising calcium silicate hydrate seeds;
a first superplasticizer; and
a second superplasticizer which is different from the first superplasticizer and which has a maximum plasticizing action at 20° C. subsequent to the maximum plasticizing action at 20° C. of the first superplasticizer.

2. The hydraulic binder as claimed in claim 1, wherein the setting and hardening accelerator additionally comprises a calcium salt.

3. The hydraulic binder as claimed in claim 2, wherein the calcium salt is calcium nitrite.

4. The hydraulic binder as claimed in claim 1, wherein the hydraulic binder does not comprise formaldehyde.

5. The hydraulic binder as claimed in claim 4, wherein the hydraulic binder does not comprise a formic derivative.

6. The hydraulic binder as claimed in claim 1, wherein the second superplasticizer comprises a hydrolyzable polymer.

7. The hydraulic binder as claimed in claim 6, wherein the second superplasticizer comprises a monomer chosen from acrylamide and its derivatives, acrylonitrile and its derivatives, alkyl acrylates, hydroxyalkyl acrylates, polyethylene glycol acrylates, copolymerizable carboxylic anhydrides and copolymerizable imides.

8. The hydraulic binder as claimed in claim 1, wherein the second superplasticizer is of the poly(alkylene oxide) polycarboxylate type.

9. The hydraulic binder as claimed in claim 1, comprising, with respect to the mass of the hydraulic binder:
from 0.1 to 9% of the setting and hardening accelerator;
from 0.1 to 5% by mass on a dry basis of the first superplasticizer; and
from 0.01 to 1% by mass on a dry basis of the second superplasticizer.

10. The hydraulic binder as claimed in claim 1, wherein the amount of the setting and hardening accelerator in the hydraulic binder is from 0.2 to 5% by mass on a dry basis with respect to the mass of the hydraulic binder.

11. The hydraulic binder as claimed in claim 1, wherein the amount on a dry basis of the second superplasticizer with respect to the setting and hardening accelerator is from 1 to 10% of the amount of the setting and hardening accelerator.

12. An accelerator mixture for a hydraulic binder, the hydraulic binder comprising cement, the mixture comprising a setting and hardening accelerator comprising calcium silicate hydrate seeds; a first superplasticizer; and a second superplasticizer which is different from the first superplasticizer and which has a maximum plasticizing action at 20° C. subsequent to the maximum plasticizing action at 20° C. of the first superplasticizer.

13. A concrete, comprising a hydraulic binder as claimed in claim 1 mixed with water.

14. The hydraulic binder as claimed in claim 1, comprising from 99 to 95% by mass of cement, with respect to the mass of the hydraulic binder.

15. The hydraulic binder as claimed in claim 1, comprising from 1 to 5% by mass with respect to the mass of the hydraulic binder of the combination of the components.
